(19) United States
(12) Patent Application Publication
(10) Pub. No.: US 2014/0172127 A1
(43) Pub. Date: Jun. 19, 2014

(54) Instrument System with Portable Computing Device

(71) Applicant: CATERPILLAR INC., Peoria, IL (US)

(72) Inventors: Lonny E. Johnson, Peoria, IL (US); Timothy Felty, East Peoria, IL (US); James Mason, Peoria, IL (US)

(73) Assignee: CATERPILLAR INC., Peoria, IL (US)

(21) Appl. No.: 13/719,560

(22) Filed: Dec. 19, 2012

(51) Int. Cl. G05B 15/02

(52) U.S. Cl. CPC G05B 15/02
USPC 700/65

(57) ABSTRACT

A system for operating a machine includes a portable computing device removably mounted on the machine. A controller is configured to determine authorized functionality of the machine based upon the data codes from the portable computing device, to determine the operating conditions of the machine and images to be displayed on a display, and generate operating commands based at least in part upon the authorized functionality. A method is also disclosed.

### TECHNICAL FIELD

The disclosure generally relates to controlling machines and, more particularly, to controlling the operation of a machine through the use of a portable computing device that may form part of an instrument panel of the machine.

### BACKGROUND

Machines including excavators, loaders, dozers, motor graders, haul trucks, and other types of equipment are used to perform a variety of tasks. In some environments, it may be desirable to prevent or limit the ability of unauthorized personnel from operating the machines.

Smart keys have been used with automobiles to provide access to a vehicle if a key is within a predetermined distance from the vehicle. A sensor may be located adjacent the doors of a vehicle and is operable to communicate with a controller when a user has activated the sensor. A mobile device external to the vehicle may wirelessly communicate with the controller when within a detection area surrounding the vehicle. Certain smart keys also provide user codes to distinguish between different operators of a vehicle and associated preset user preferences.

Systems also exist for utilizing a portable computing device as part of an instrument panel of a vehicle to provide consumers with a personalized driving experience and infotainment services. The portable computing device may communicate with vehicle components wirelessly or through a wired connection, and may communicate with components through a communications gateway or other interface. The portable computing device may also supplement the instrument panel of the vehicle.

U.S. Pat. No. 6,246,935 discloses a system in which a stand-alone removable computer may be provided to exchange information between the computer and a vehicle. The vehicle may be operated with or without the computer being mounted in the vehicle. Upon mounting the computer in the vehicle, the computer may be video-linked to an information display of the instrument panel of the vehicle to supplement or enhance the vehicle functionality.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a system for operating a machine includes a plurality of sensors for generating signals indicative of operating conditions of the machine and a display for displaying images related to the operating conditions of the machine. A portable computing device is removably mounted on the machine and has a processor, a data storage system including a plurality of data codes, and a communications interface. A controller is configured to communicate with components of the portable computing device, receive signals from the plurality of sensors, and determine authorized functionality of the machine based upon the data codes. The controller is further configured to determine the operating conditions of the machine based upon the signals received from the plurality of sensors, determine images to be displayed on the display based at least in part upon the operating conditions, and generate operating commands based at least in part upon the authorized functionality.

In another aspect, a controller implemented method of operating a machine, includes removably mounting a portable computing device on the machine, and wherein the portable computing device has a processor, a data storage system including a plurality of data codes, and a communications interface. The method includes communicating with components of the portable computing device, receiving signals from a plurality of sensors indicative of operating conditions of the machine, and determining authorized functionality of the machine based upon the data codes. The method further includes determining the operating conditions of the machine based upon the signals received from the plurality of sensors, determining images to be displayed on a display based at least in part upon the operating conditions, and generating operating commands based at least in part upon the authorized functionality.

In another aspect, a machine includes a prime mover, a plurality of sensors for generating signals indicative of operating conditions of the machine, and a display for displaying images related to the operating conditions of the machine. A portable computing device is removably mounted on the machine and includes a processor, a data storage system including a plurality of data codes, and a communications interface. A controller is configured to communicate with components of the portable computing device, receive signals from the plurality of sensors, and determine authorized functionality of the machine based upon the data codes. The controller is further configured to determine the operating conditions of the machine based upon the signals received from the plurality of sensors, determine images to be displayed on the display based at least in part upon the operating conditions, and generate operating commands based at least in part upon the authorized functionality.

### BRIEF DESCRIPTION OF THE DRAWINGS

FIG. 1 is a side elevational view of a motor grader;

FIG. 2 is a schematic representation of an instrument array;

FIG. 3 is a front view of a portion of an operator cab including an instrument array;

FIG. 4 is a schematic representation of a portable computing device;

FIG. 5 is an example of images displayed on a display of the machine;

FIG. 6 is a view similar to FIG. 5 but with different images displayed based on a first machine operation;

FIG. 7 is a view similar to FIG. 5 but with still different images displayed based on a second machine operation;

FIG. 8 is a block diagram of a control system in accordance with the disclosure; and

FIG. 9 is a flowchart illustrating a process for operating a machine in accordance with the disclosure.

### DETAILED DESCRIPTION

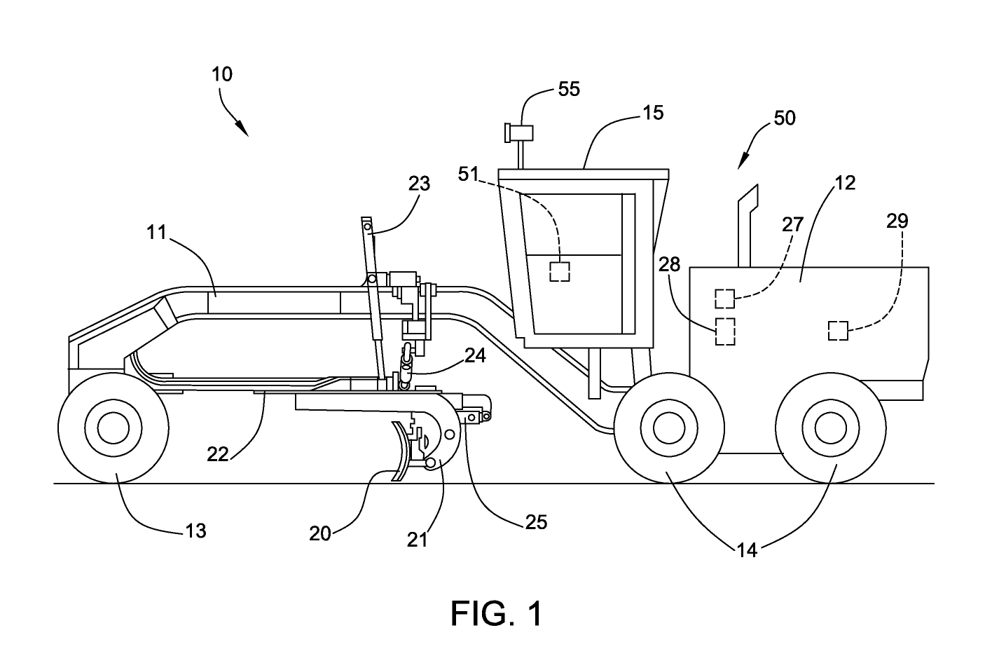

FIG. 1 is a diagrammatic illustration of machine 10 such as a motor grader that may be used in accordance with an embodiment of the disclosure. The motor grader includes a frame 11 and a prime mover such as an engine 12. A set of front wheels 13 may be operatively connected to the frame 11 generally adjacent a front end of the motor grader and two sets of rear wheels 14 may be operatively connected to the frame 11 generally adjacent a rear end of the motor grader. In an alternate embodiment, only a single set of rear wheels 14 may be provided. One or both sets of rear wheels 14 may be powered by a power transfer mechanism (not shown) operatively connected to the engine 12. The power transfer mechanism may be any desired type of drive system including a hydrostatic propulsion system, an electric drive system or a mechanical drive system. An operator cab 15 may be mounted on the frame 11 and may include various controls, gauges, displays and other mechanisms used by an operator.

A work implement such as a blade or moldboard 20 extends downward from the frame 11. The moldboard 20 may be mounted on a blade tilt adjustment mechanism 21 that is supported by a rotatable circle assembly 22 operatively connected to the blade tilt adjustment mechanism 21. A variety of hydraulic cylinders or actuators may be provided for controlling the position of the moldboard 20. For example, circle assembly 22 may be supported by a pair of blade lift actuators 23 (with only one visible in FIG. 1). Adjustment of the blade lift actuators 23 allows the height of rotatable circle assembly 22, and hence the height of moldboard 20, to be adjusted. Blade lift actuators 23 may be moved independently or in combination with each other. A center shift cylinder 24 may be provided to shift the circle assembly 22 from side-to-side. A blade tip cylinder 25 may be provided to control the angle between an edge of the moldboard 20 and the ground. One or more side shift cylinders (not shown) may be provided to control lateral movement of the moldboard 20 relative to the circle assembly 22. The circle assembly 22 may include a mechanism such as gear teeth to allow rotation of the moldboard 20. Other manners of positioning and controlling the moldboard 20 may be utilized if desired.

The machine 10 may be equipped with a plurality of sensors or sensing devices that gather data from various components and systems and generate signals that are directly or indirectly indicative of the performance and operating conditions of the machine. The sensors may generate signals indicative of operating conditions of the machine. Sensors may be associated with, for example, the engine 12, a transmission (not shown), a torque converter (not shown), the front wheels 13, the rear wheels 14, the operator cab 15, the moldboard 20, various actuators such as the blade lift actuators 23, the center shift cylinder 24, the blade tip cylinder 25, fluid supplies (not shown), operator input devices, a parking brake and/or other systems and components of machine 10. These sensors may automatically gather real-time data such as the operation of engine 12, the position of and load on the work implement, fluid pressure, flow rate, temperature, contamination level, and/or viscosity, fluid (i.e., fuel, oil, water, etc.) consumption rates, electric current and/or voltage levels, loading levels (e.g., payload value, percent of maximum allowable payload limit, payload history, payload distribution, etc.), transmission output ratio, and other desired information.

In addition, various sensors may be associated with the machine 10 that may be used to determine machine travel characteristics (e.g., speed, acceleration, torque, slip rate, etc.) as well as the position and orientation of machine 10. For example, an accelerometer 27 may be provided on the machine 10 to provide an acceleration signal indicative of measured acceleration of the machine 10 relative to a gravity reference. In one example, the accelerometer 27 may provide measurements in six degrees of freedom (i.e., fore-aft, lateral, and vertical directions as well as pitch, roll and yaw). In some circumstances, it may be desirable to position the accelerometer 27 generally adjacent operator cab 15 so that movement sensed by the accelerometer somewhat matches movement sensed by an operator.

Still further, a pitch rate sensor 28 (e.g., a gyroscope) may be provided on the machine 10. The pitch rate sensor 28 may be used to provide a pitch rate signal indicative of a pitch rate of the machine 10. As the machine 10 moves, the pitch rate will be indicative of the rate of change of the pitch angle of the machine. The pitch rate sensor 28 may also be used to determine the pitch and roll of the machine 10.

A position sensor 29 may sense a position of the machine 10. The position sensor 29 may include a plurality of individual sensors that cooperate to provide signals to controller 51 to indicate the position of the machine 10. The controller 51 may determine the position of the machine 10 as well as its orientation (i.e., the direction machine 10 is facing). In some instances, the position sensor 29 may be used to determine the pitch and roll of the machine 10. The position sensor 29 may be a series of global positioning system sensors, an odometer or other wheel rotation-sensing sensor, a perception based system or may use other systems such as lasers to determine the position of machine 10.

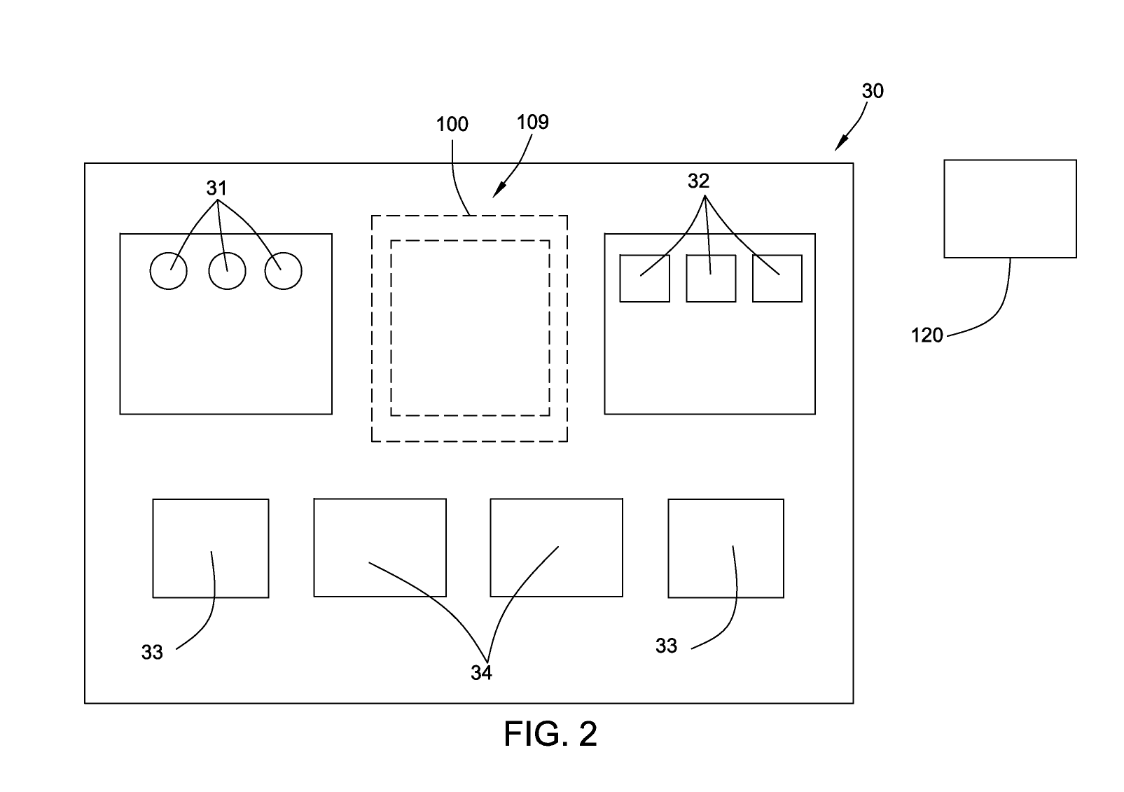

As depicted schematically in FIG. 2, the operator cab 15 may include an instrument array 30 including one or more display devices and one or more input devices. Each display device may function as a machine display device for displaying images related to the operating conditions of the machine. More specifically, machine 10 may include a plurality of fixed or stationary display devices such as gauges 31 and displays 32 that are permanently mounted within the operator cab 15. As referred to herein, a gauge 31 may have a fixed functionality such that it always reflects or measures the same function (e.g., a fuel gauge, a temperature gauge, a pressure gauge). As referred to herein, a display 32 may have a modifiable or changeable functionality such that it may reflect or measure different functions (e.g., a backup camera display, machine speed, engine speed, or machine event warning display center). Each of the displays 32 may include a computer screen or some other type of display upon which an image such as a computer-generated image may be displayed. Examples of the images displayed on a machine display may include a circular dial, a color-coded indicator, a graph or any other image for conveying information.

Each input device may function as a machine input device for providing commands or data input such as inputting information, changing operations, and issuing commands to the machine 10 and to a remote system 120. More specifically, machine 10 may include a plurality of fixed or stationary input devices such as buttons, knobs, dials, levers, joysticks, and other controls that are permanently mounted within the operator cab 15. One or more of the stationary input devices may have a fixed functionality (referred to herein as a fixed function input device 33) such that they are always used to control the same function (e.g., on/off switches, cab temperature controls, pedals, radio controls). One or more of the stationary input devices may have a modifiable or changeable functionality (referred to herein as a modifiable function input device 34) such that they may be modified to control the input of different functions (e.g., cab temperature, machine lights, or engagement of auto blade position set features). Examples of modifiable function input devices 34 include a touch screen display with a computer-generated image, a knob adjacent a computer display, or any other desired input device.

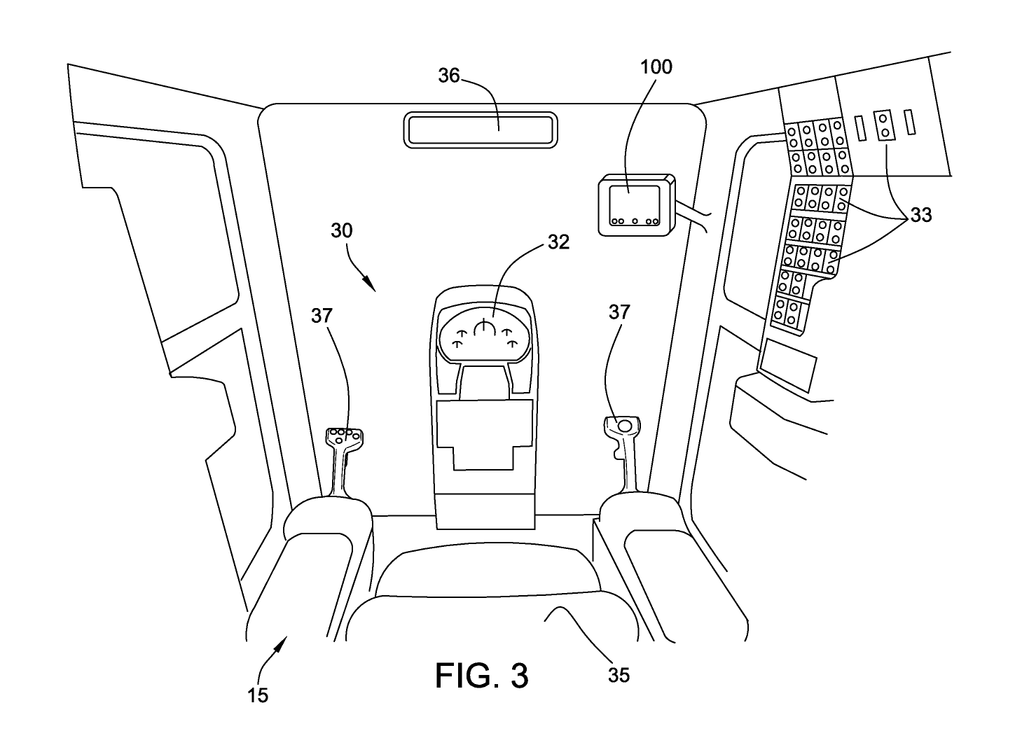

FIG. 3 depicts a portion of an interior of operator cab 15. Operator cab 15 may include a seat 35 with an adjacent instrument array 30. The instrument array 30 may include a centrally positioned display 32 and a rear view camera display 36 positioned above the display 32. The rear view camera display 36 may be used to display other information if desired. The instrument array 30 may also include a plurality of fixed function input devices 33 in the form of switches and knobs. Still further, the instrument array may include a plurality of joysticks 37 that may function as fixed function or variable or modifiable function input devices. A portable computing device 100 may be removably mounted in operator cab 15 as described below. The portable computing device 100 may form a portion of the instrument array 30.

A control system 50 may be provided to control the operation of the machine 10. The control system 50, as shown generally by an arrow in FIG. 1 indicating association with the machine 10, may include an electronic control module such as controller 51. The controller 51 may receive operator input command signals and control the operation of the various systems of the machine 10. The control system 50 may include one or more input devices to control the machine 10 and one or more sensors to provide data and other input signals representative of various operating conditions of the machine 10.

The controller 51 is shown in FIG. 1 adjacent the operator cab 15 but may be mounted at any convenient location on machine 10. The controller 51 may be an electronic controller that operates in a logical fashion to perform operations, execute control algorithms, store and retrieve data and other desired operations. The controller 51 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller such as power supply circuitry, signal conditioning circuitry, driver circuitry, and other types of circuitry.

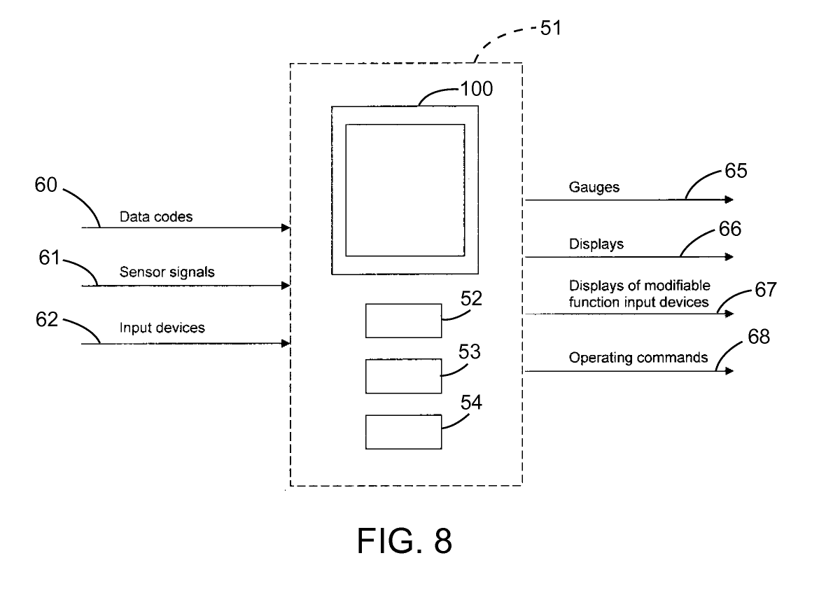

The controller 51 may be a single controller or may include more than one controller disposed to control various functions and/or features of the machine 10. In one embodiment depicted in FIG. 8, the controller 51 may include a machine controller 52 for controlling aspects of machine 10, an engine controller 53 for controller aspects of engine 12, and an implement controller 54 for controlling aspects of the work implement. In another embodiment, machine controller 52 may control aspects of the machine 10, the engine 12, and the work implement. The term “controller” is meant to be used in its broadest sense to include one or more controllers and/or microprocessors that may be associated with the machine 10 and that may cooperate in controlling various functions and operations of the machine. The functionality of the controller 51 may be implemented in hardware and/or software without regard to the functionality. The controller 51 may rely on one or more data maps relating to the operating conditions of the machine 10 that may be stored in the memory of controller. Each of these maps may include a collection of data in the form of tables, graphs, and/or equations. The controller 51 may use the data maps to maximize the efficiency of the machine 10.

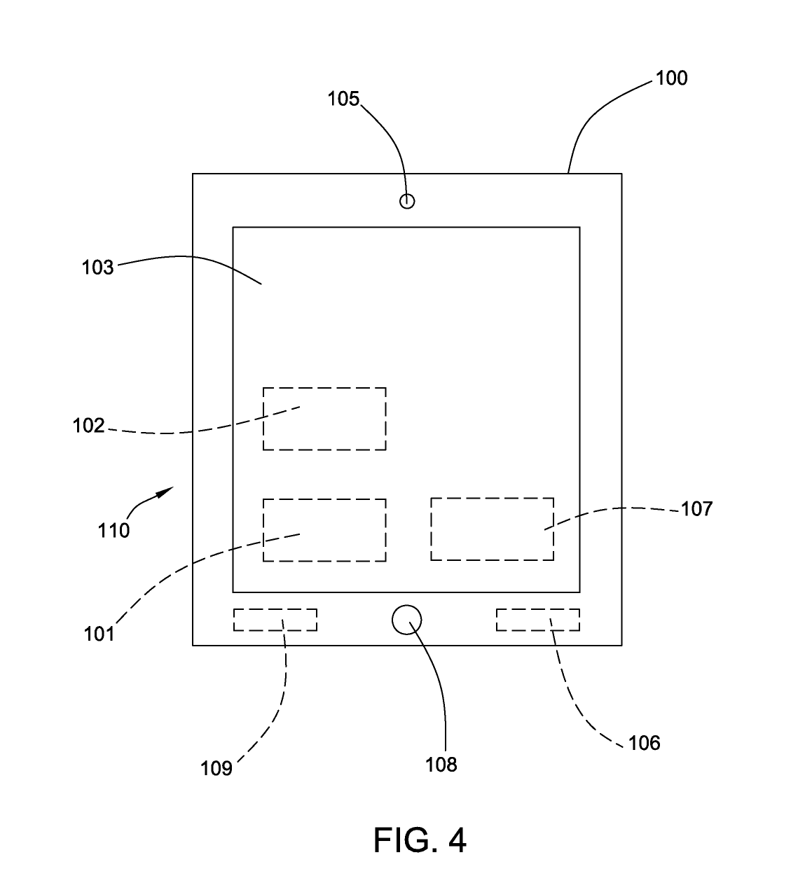

As depicted in FIG. 2, a portable computing device 100 may be removably mountable on the machine. The portable computing device 100 may include a central processing unit 101 (FIG. 4), a data storage system 102 such as memory and/or a secondary storage device, and other components for running an application. The central processing unit 101, the data storage system 102, and other aspects of the portable computing device 100 may act as a portable device controller 110 that interacts with machine controller 52 as a component of the controller 51. The portable computing device 100 may also include a display 103, a communications interface such as a wireless interface 104, a camera 105, a microphone 106, a global positioning sensor 107, and one or more input devices 108. If desired, the portable computing device 100 may be removably mounted within operator cab 15 within a docking device or station. As a result, the display 103 may function as a portable device display relative to machine 10. The docking device may function as a machine mounting location 109 for removably mounting the portable computing device 100 thereat to provide power to charge the portable computing device 100 as well as provide data connections to machine 10.

The display 103 may be configured as a touch screen to also operate as a portable device input. The wireless interface 104 may provide a communications channel between the machine controller 52 and the portable computing device 100 as well as between the controller 51 and a remote system 120. In one embodiment, the wireless communication between the machine controller 52 and the portable computing device 100 may be via a Bluetooth® communications system or protocol. Other communications systems and protocols are contemplated. In an alternate embodiment, a wired communications interface (not shown) may be provided to effect the connection between the machine controller 52 and the portable computing device 100. Communication between the machine controller 52 and the portable computing device 100 may be achieved by a wireless connection that occurs once the portable computing device is within a predetermined distance of the machine 10. In another embodiment, communication between the machine controller 52 and the portable computing device 100 may be achieved by a wired connection upon mounting the portable computing device in or on the machine 10. In other words, portable computing device 100 may be configured to communicate with the machine controller wirelessly or through a wired connection.

Components of the portable computing device 100 may supplement or replace some of the components of machine 10. For example, the functionality of controller 51 may be distributed so that certain functions are performed by the machine controller 52 and other functions are performed by the portable computing device 100. In addition, sensors, displays and input devices of the portable computing device 100 may supplement or replace some of the sensors, displays, gauges, and input devices of machine 10. For example and as described in further detail below, the display 103 of the portable computing device 100 may be used to supplement or replace displays permanently mounted on the machine 10. Similarly, the wireless interface 104 of the portable computing device 100 may also be used to supplement or replace a wireless interface of the machine 10.

The camera 105 of the portable computing device 100 may be used to capture images of the work site or the machine 10. These images may be stored in the machine controller 52, in the portable computing device 100, or in a remote system 120 wirelessly connected to the controller 51. Further, the portable computing device 100 may be mounted within operator cab 15 so that camera 105 may be used to monitor actions of an operator such as tracking an operator's eyes to monitor for potential signs of fatigue. Microphone 106 of portable computing device 100 may be used to receive voice commands from an operator and provide the voice commands to the controller 51. The controller may thus be able to operate components or control certain aspects of the operation of machine 10 based upon those voice commands and thus reduce the need for additional input devices. The microphone 106 may also be used to communicate or record notes regarding the operations at the work site or the operation of the machine 10 such as noted hazards or required maintenance items. The global positioning sensor 107 of the portable computing device 100 may used to supplement or replace the sensors of position sensor 29, if desired. As a result, the display 103 and other components of the portable computing device 100 may supplement or combine with the machine display devices and the machine input devices to form a machine instrument array made up of the instrument array 30 and the portable computing device.

In an alternative embodiment, the portable computing device 100 may control and operate all aspects of the machine 10 and thus the portable computing device 100 may function as the controller 51. Regardless of whether the connection between the machine controller 52 and the portable computing device 100 is wired or wireless and regardless of whether controller 51 includes machine controller 52, aspects of the control system 50 may be located remote from the machine 10 and controller 51 may communicate wirelessly to remote system 120 that forms a part of the control system 50.

The portable computing device 100 may store as data codes a plurality of user or operator preferences such as the temperature of the operator cab 15, the settings of the seat within the operator cab 15, input device sensitivity, and desired display images based upon certain operating conditions. Upon docking the portable computing device 100 or moving it within a predetermined range in the case of a wireless connection, the machine controller 52 and the portable computing device may communicate so that controller 51 will operate with the user preferences saved within the portable computing device. The data codes may further include a user identification data code that is specific or unique to each machine operator. As a result, upon docking the portable computing device 100, the controller 51 may determine the identity of the machine operator based upon the user identification data code.

The controller 51 may be configured so that machine 10 is inoperable without portable computing device 100. For example, portable computing device 100 may have saved therein data codes such as authorization keys that prevent the operation of the machine controller 52 without such authorization keys. By requiring appropriate authorization keys, it may be possible to limit an operator's use to only certain types or models of machines 10. More specifically, each operator may be assigned a specific portable computing device 100 and that portable computing device may be set up so as to limit an operator to operate only certain types or models of machines. Still further, the portable computing device 100 may limit an operator to operating one or more specific machines.

The controller 51 may be further configured to limit the operation of machine 10 based upon data codes in the form of limited access keys stored within portable computing device 100. The limited access keys may be used to limit the types of operations performed with the machine 10 as well as limit the time or location at which the machine is operated. For example, a limited access key may be used to prevent an inexperienced operator from performing certain operations (e.g., to prevent operation without sufficient training) In another example, an operator may be prohibited from clearing certain types of data such as performance data as well as fault or error codes. The limited access keys may further be used to prevent a machine 10 from being moved outside of a predetermined area (e.g., outside of a global positioning system defined fence) or from being moved or performing certain operations outside of a predetermined range of hours or times.

Machine operators may be provided with one set or type of limited access keys while maintenance personnel may be provided with a different set or type of limited access keys. As a result, maintenance personnel may be prevented from performing certain operations such as moving a machine or operating certain implements and operators may be prevented from accessing certain components or panels of the machine that should only be accessed by maintenance personnel. Through such limited access keys, a work site manager or machine owner may be able to match the use and access to the machines 10 based upon the ability and authorization of the various personnel. Still further, a record of such use and access may be stored within the portable computing device 100 and/or communicated wirelessly to remote system 120.

As described above, the operator cab 15 may include a plurality of fixed or stationary display devices such as gauges 31 and displays 32 that are permanently mounted within the operator cab 15 as part of the machine instrument array. Other display devices may be removably mounted on the machine 10 such as within the operator cab 15. In one example, if the portable computing device 100 is removably positioned within the operator cab 15, the display 103 of the portable computing device may be used as an additional or portable display within the operator cab. As with the displays 32 that are fixed within the operator cab 15, the display 103 of a portable computing device 100 may be used to display any type of image including those that resemble gauges. The gauges 31, the displays 32, and the display 103 of the portable computing device 100 may interact to form a display system such as the instrument array 30 of machine 10.

As also described above, the operator cab 15 may include a plurality of fixed or stationary input devices such as fixed function input devices 33 and modifiable function input devices 34 that are permanently mounted within the operator cab 15. Other input devices may be removably mounted on the machine 10 such as within the operator cab 15. If the portable computing device 100 is removably positioned within the operator cab 15 and the display 103 includes touch screen functionality, a portion of the display may be used as an input device with modifiable functionality. Still further, the portable computing device 100 may include other components such as microphone 106 that may be used as input devices to control the operation of machine 10. The fixed function input devices 33, the modifiable function input devices 34, and aspects of the portable computing device 100 may interact to form an input system of machine 10.

The controller 51 may be configured to control the images displayed on each of the modifiable displays and gauges. The controller 51 may display different images depending on the operation being performed and the operating conditions of the machine 10. In one example, upon starting machine 10, the displays may indicate the machine status, the temperature of various fluids, and the fuel level. After reporting and confirming the initial levels, it may be desirable to only display this information upon a material change, at predetermined time intervals, or upon the request of an operator.

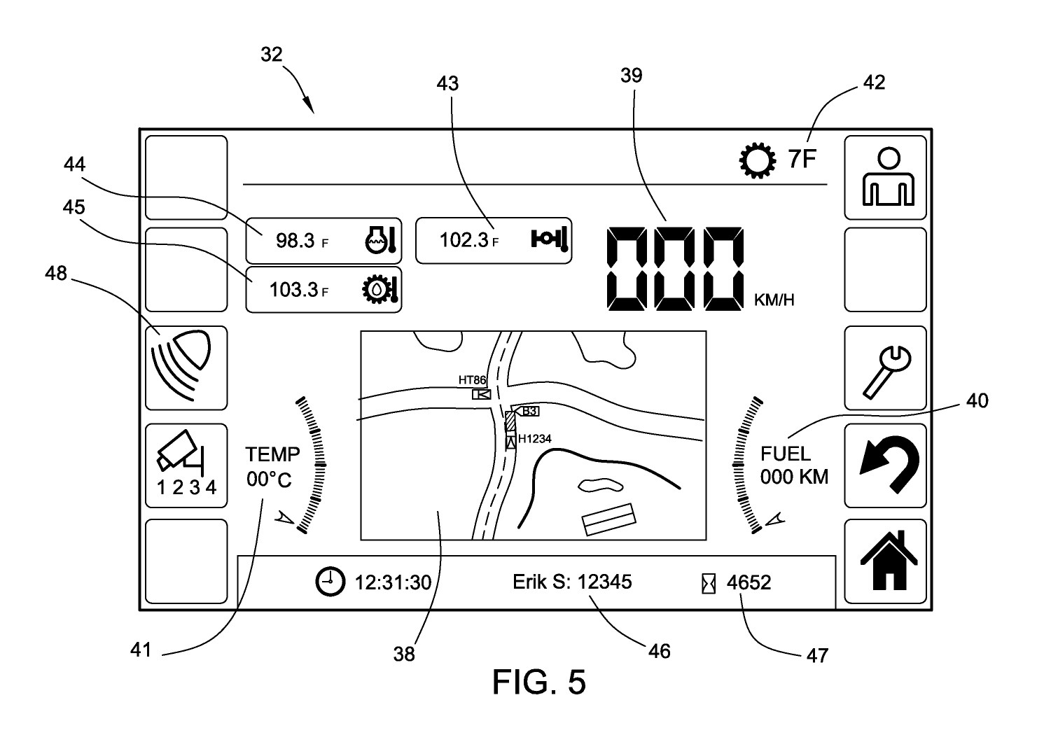

The controller 51 may change the images being displayed based upon the operation being performed. For example, in FIG. 5, a display 32 is depicted for basic operation of machine 10. The display 32 depicts various images such as a map 38, a speedometer 39, a fuel gauge 40, and a coolant temperature gauge 41. The display 32 may also include a gear selection image 42, a differential fluid temperature gauge 43, an engine oil temperature gauge 44, and a transmission oil temperature gauge 45. The display may further identify the name of the operator and an identification code at 46, the number of hours since the engine was last serviced at 47, the status of machine lights at 48.

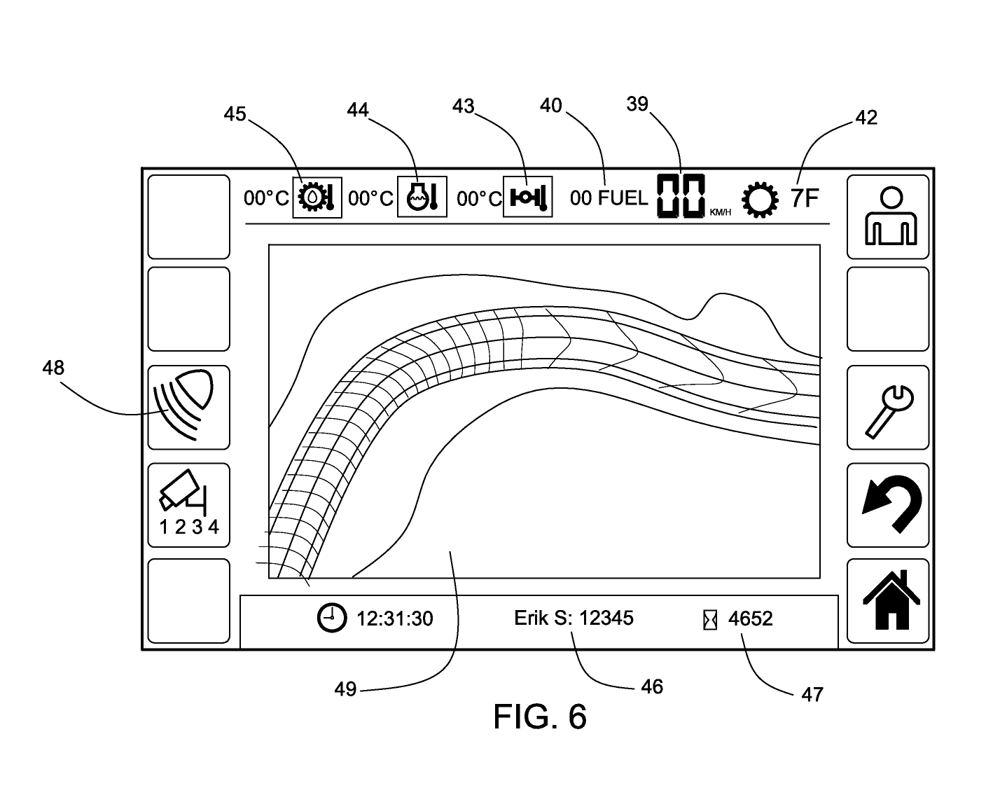

When the motor grader is performing a grading operation, it may be desirable to only depict some of the images displayed in FIG. 5. As shown in FIG. 6, the map 38 has been replaced by an image 49 from a grade control system and the coolant temperature gauge 41 has been removed. The speedometer 39, the fuel gauge 40, the differential fluid temperature gauge 43, the engine oil temperature gauge 44, and the transmission oil temperature gauge 45 have all been moved to be in line along an upper row of the display 32. With this configuration, the operator may be primarily focused on the image 49 from the grade control system.

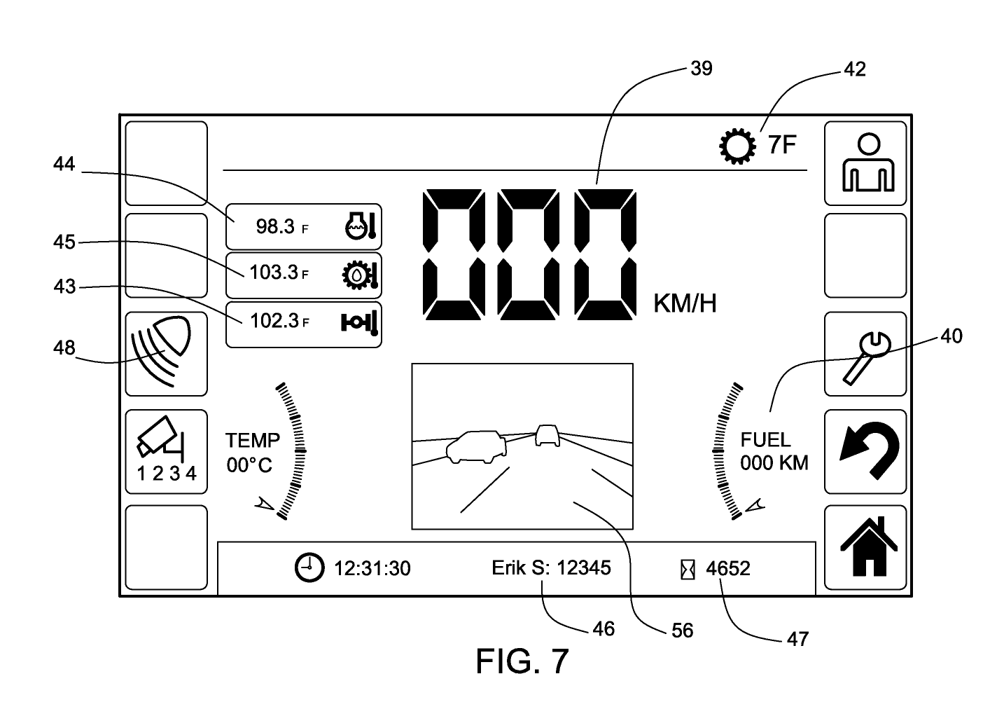

In another operation such as the motor grader operating on a road, different images may be displayed as depicted in FIG. 7. In such case, the speedometer 39 and images 56 from cameras depicting the area around the motor grader may be emphasized in the display 32.

If an emergency alert or alarm occurs, the controller 51 may display an image on display 32 related to the emergency alert or alarm as well as instructions as to the appropriate steps to be taken or operations to be performed. For example, if one or more of the fluid temperatures exceeds a predetermined threshold, the controller 51 may generate a warning for the operator on the display 32.

Although described above with respect to a motor grader, the present disclosure may be applicable to many other types of machines. For example, when operating a wheel loader, controller 51 may display an indication of how close the wheels are to slipping. This information may be used by an operator to maximize or increase the performance of the wheel loader. In another example, when loading an excavator or a wheel loader, the controller 51 may display mass or weight of the load in the work implement of the machine.

FIG. 8 depicts a control diagram upon operatively mounting the portable computing device 100 on machine 10. As depicted, the machine controller 52, the engine controller 53, the implement controller 54, and the portable device controller 110 may interact as controller 51. Controller 51 may receive, at node 60, data codes that may be stored within a data storage system 102 such as memory or a secondary storage device of portable computing device 100. In some embodiments, it may possible for the data codes to be stored within a remote system 120 and transferred to controller 51 such as by the portable computing device 100. The data codes may include user preferences for setting aspects of the machine 10 that may be set by an operator such as the temperature of the operator cab 15, setting of the seat within the operator cab, and input device sensitivity. By storing the user preferences on the portable computing device 100, each machine 10 may be configured to an operator's desired characteristics upon docking the portable computing device 100 within the machine. As a result, the amount of time necessary to set up a machine 10 when being used by a new operator may be minimized.

Additional data codes may include authorization keys so that an operator may only use those machines for which proper authorization has been received. Still further, the data codes may include limited access keys so that only certain types of operations may be performed by an operator or other personnel (e.g., a mechanic) based upon the stored limited access keys.

At node 61, the controller 51 may receive signals from the various sensors associated with various aspects of machine 10 as well as any sensors associated with portable computing device 100. At node 62, the controller 51 may receive signals from various input devices associated with machine 10 and portable computing device 100.

The controller 51 may generate various output signals based upon the data codes received at node 60, the sensor signals received at node 61, and the signals from the input devices received at node 62. At node 65, the controller 51 may generate output signals that are transmitted to the gauges 31. In other words, the controller 51 may generate signals that are transmitted to the display devices in which the function is fixed. At node 66, the controller 51 may generate signals or images that are transmitted to the displays 32. More specifically, based upon the user preferences, the operating conditions of the machine 10, and any input commands from an operator, the controller 51 may determine the information to be displayed on the displays 32. In doing so, the controller 51 may also determine which images should be displayed on the display 103 of the portable computing device 100. At node 67, the controller 51 may generate signals or images that are transmitted to displays associated with the modifiable function input devices 34 including any associated with portable computing device 100. At node 68, the controller 51 may generate operating commands to control the operation of machine 10.

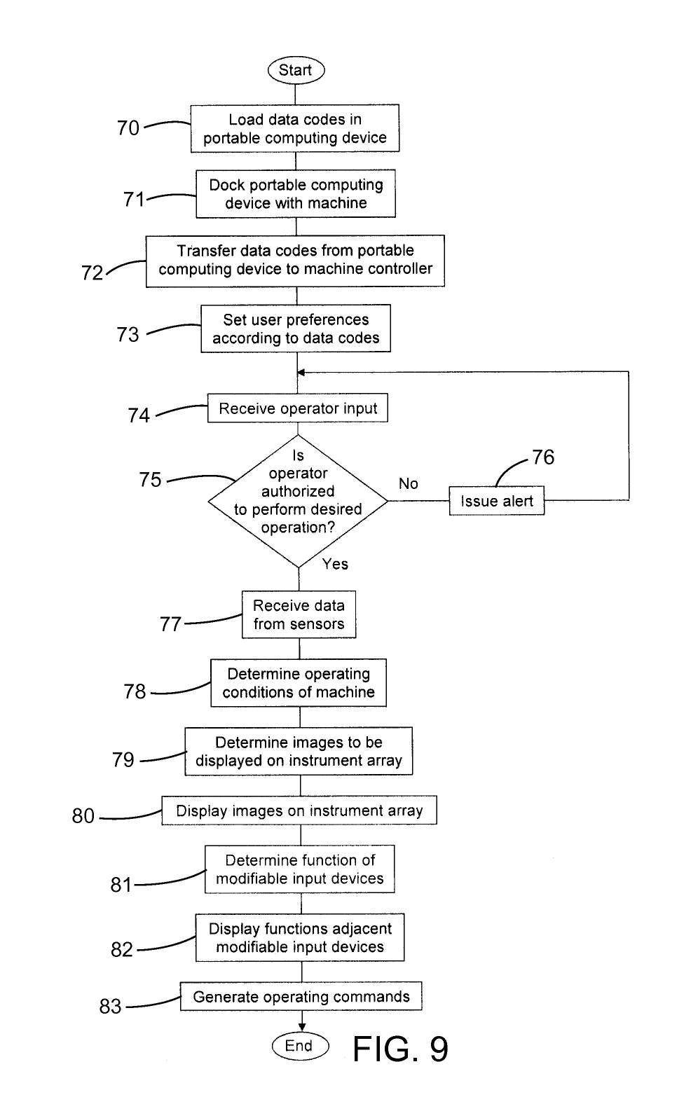

FIG. 9 depicts a flowchart of a process for operating machine 10 including a portable computing device 100. At stage 70, the data codes may be entered or loaded into portable computing device 100. In order to operate machine 10, the data codes may include an authorization key for at least one type of machine. If limited access keys are utilized, the limited access key may authorize at least one operation of the machine 10. At stage 71, the portable computing device 100 may be docked with machine 10. Such docking may occur wirelessly by moving the portable computing device 100 within a predetermined distance from the machine 10 or through a wired connection by physically connecting the portable computing device to an appropriate docking connection or interface (not shown) of the machine.

The data codes may be transferred at stage 72 from the portable computing device 100 to the machine controller 37. At stage 73, the machine controller 37 may set the user preferences according to the data codes transferred at stage 72. At stage 74, the controller 36 may receive various input signals from an operator. At decision stage 75, the controller 36 may begin an authorization process to determine whether the operator is authorized to operate the machine 10 and to perform the desired operation as requested by the operator input at stage 74. In determining whether the operator is so authorized, the controller 36 may analyze the data codes received at stage 72 to determine whether the operator is authorized to operate the machine 10 and whether the specific operations requested are also authorized. If the operator is not authorized to operate the machine 10 and to perform the desired operation, an alert may be issued at stage 76. This alert may include an alarm or other notification within the operator cab 15 as well as transmitting a signal wirelessly to the remote system 120.

If the operator was authorized to perform the desired operation at decision stage 75, the controller may receive data at stage 77 data from the various sensors associated with machine 10 and portable computing device 100. The sensors may generate signals indicative of operating conditions of the machine 10. At stage 78, the controller 36 may determine the operating conditions of machine 10 based upon the data received from the sensors at stage 77. At stage 79, the controller 36 may determine based at least in part on the operating conditions of the machine 10 which images should be displayed on the displays 32 of the machine and which images should be displayed on the display 103 of the portable computing device 100. The controller may generate at stage 80 signals necessary to display the desired images on the instrument array 30. If any of the input devices are configured as modifiable function input devices 34, the controller 36 may determine at stage 81 the function of such modifiable function input devices. In addition, the controller 36 may generate at stage 82 signals to display an image generally adjacent each such modifiable function input device 34 so as to communicate the functionality to an operator. At stage 83, the controller 36 may generate operating commands to operate 10 the machine as desired based upon the data codes, the signals received from the sensors, and the input from the operator.

### INDUSTRIAL APPLICABILITY

The industrial applicability of the system described herein will be readily appreciated from the foregoing discussion. The foregoing discussion is applicable to machines such as excavators, loaders, dozers, and motor graders in which it is desirable to prevent or limit the operation of the machines by unauthorized personnel. In one example, a machine 10 may be inoperable without a portable computing device 100 having the necessary data codes. In another example, the machine 10 and portable computing device 100 may be configured to only permit personnel to perform those operations and tasks authorized by data codes associated with the portable computing device.

In another aspect, the portable computing device may include or access data codes that provide user preferences for the operation of the machine. In addition to setting a desired seat position, radio controls, and other similar aspects of the machine, the user preferences may also establish images to be displayed on an instrument array 30 depending on the operating conditions experienced by the machine 10. In one example, a first operator may be sufficiently experienced to perform certain tasks or operations without additional assistance. A second, less experienced operator may find the display of certain images to be useful or helpful to perform the same tasks or operations. Permitting the operator cab 15 and, more specifically, the displays and input devices to be modifiable may simplify the operation of machine 10 and potentially permit a relatively inexperienced operator to control the machine 10 in a manner more similar to that of an experienced operator.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for operating a machine, comprising:
a plurality of sensors for generating signals indicative of operating conditions of the machine;
a display for displaying images related to the operating conditions of the machine;
a portable computing device removably mounted on the machine, the portable computing device having:
a processor;
a data storage system including a plurality of data codes; and
a communications interface; and
a controller configured to:
communicate with components of the portable computing device;
receive signals from the plurality of sensors;
determine authorized functionality of the machine based upon the data codes;
determine the operating conditions of the machine based upon the signals received from the plurality of sensors;
determine images to be displayed on the display based at least in part upon the operating conditions; and
generate operating commands based at least in part upon the authorized functionality.

2. The system of claim 1, wherein the machine includes a machine display mounted on the machine for displaying information related to the operating conditions of the machine, the portable computing device includes a portable display for displaying information related to the operating conditions of the machine, and wherein the controller is further configured to determine images to be displayed on each of the machine display and the portable display based at least in part upon the operating conditions of the machine.

3. The system of claim 2, wherein the machine display is permanently mounted on the machine.

4. The system of claim 1, wherein the machine further includes a machine controller, the portable computing device and machine controller are configured to communicate wirelessly.

5. The system of claim 4, further including a remote system distinct from the machine and the portable computing device, and at least one of the controller and the portable computing device is configured to communicate with the remote system.

6. The system of claim 1, wherein the plurality of data codes includes an authorization key for at least one type of machine.

7. The system of claim 1, wherein the plurality of data codes includes an limited access key to authorize at least one operation of the machine.

8. The system of claim 1, wherein the plurality of data codes includes a range of hours during which the machine may be operated.

9. The system of claim 1, wherein the plurality of data codes defines a predetermined area within which the machine may be operated.

10. The system of claim 1, wherein the plurality of data codes includes a plurality of operator preferences.

11. The system of claim 1, wherein the machine and the portable computing device each includes at least one input device for providing data input to the controller.

12. The system of claim 11, wherein the portable computing device is configured to receive voice commands from an operator and the controller is configured to operate components of the machine based upon the voice commands.

13. The system of claim 1, wherein the portable computing device includes a global positioning sensor, and the controller is further configured to determine the position of the machine based at least in part upon the global positioning sensor of the portable computing device.

14. A method of operating a machine, comprising:
removably mounting a portable computing device on the machine, the portable computing device having:
a processor;
a data storage system including a plurality of data codes; and
a communications interface;
communicating with components of the portable computing device;
receiving signals from a plurality of sensors indicative of operating conditions of the machine;
determining authorized functionality of the machine based upon the data codes;
determining the operating conditions of the machine based upon the signals received from the plurality of sensors;
determining images to be displayed on a display based at least in part upon the operating conditions; and
generating operating commands based at least in part upon the authorized functionality.

15. The method of claim 14, wherein the machine includes a machine display mounted on the machine for displaying information related to the operating conditions of the machine, the portable computing device includes a portable display for displaying information related to the operating conditions of the machine, and further including determining images to be displayed on each of the machine display and the portable display based at least in part upon the operating conditions of the machine.

16. The method of claim 14, wherein determining the authorized functionality of the machine includes determining at least one operation of the machine.

17. The method of claim 14, wherein determining the authorized functionality of the machine includes determining a range of hours during which the machine may be operated.

18. The method of claim 14, wherein determining the authorized functionality of the machine includes determining a predetermined area within which the machine may be operated.

19. The method of claim 14, wherein the portable computing device includes a global positioning sensor, and further determining the position of the machine based at least in part upon the global positioning sensor of the portable computing device.

20. A machine comprising:
a prime mover;
a plurality of sensors for generating signals indicative of operating conditions of the machine;
a display for displaying images related to the operating conditions of the machine;
a portable computing device removably mounted on the machine, the portable computing device having:
a processor;
a data storage system including a plurality of data codes; and
a communications interface; and
a controller configured to:
communicate with components of the portable computing device;
receive signals from the plurality of sensors;
determine authorized functionality of the machine based upon the data codes;
determine the operating conditions of the machine based upon the signals received from the plurality of sensors;
determine images to be displayed on the display based at least in part upon the operating conditions; and
generate operating commands based at least in part upon the authorized functionality.
